(19) United States
(12) Patent Application Publication
(10) Pub. No.: US 2012/0200248 A1
(43) Pub. Date: Aug. 9, 2012

(54) METHOD FOR MONITORING A DRIVE STATE OF AN ELECTRIC MOTOR

(76) Inventor: Roland Schleser, Saarbruecken (DE)

(21) Appl. No.: 13/390,228

(22) PCT Filed: Jul. 19, 2010
(86) PCT No.: PCT/EP10/60392

§ 371 Date: Apr. 26, 2012

(30) Foreign Application Priority Data
Aug. 13, 2009 (DE) 10 2009 028 502.4

(51) Int. Cl. H02P 6/12

(52) U.S. Cl. 318/490

(57) ABSTRACT

A method for monitoring a drive state, particularly a non-driven drive state of an electric motor, which is fed with energy using a bridge inverter having at least one half bridge, having detecting of a state of the at least one half bridge, detecting a property of a control signal for driving the at least one half bridge, and monitoring the drive state based on the detected state of the at least one half bridge and the detected property of the control signal.

### FIELD OF THE INVENTION

The present invention relates to the monitoring of drive states, particularly of non-driven drive states of electric motors.

### BACKGROUND INFORMATION

For the purpose of supplying electric motors, particularly multiphase synchronous motors, with electrical energy, bridge inverters are usually used, which have in each case, for instance, three upper and three lower half bridges. On the input side, the half bridges are supplied with electrical energy from an energy store, for instance, a battery, having a positive voltage terminal and a negative voltage terminal or ground. The half bridges may include semiconductor switches, the upper half bridges being provided for positive voltages and lower half bridges for negative voltages or for ground. In operation, the half bridges of the bridge inverter are actuated suitably in order to provide the electric motor the electrical power required for producing a setpoint torque Dₛₑₜₚₒᵢₙₜ. Setpoint torque Dₛₑₜₚₒᵢₙₜ of a synchronous motor of an electric drive of an electric vehicle or a hybrid vehicle that is electronically permuted, for example, is usually set via the phase current of the coils of the synchronous motor. The setting of these currents takes place by a clock-pulsed application of a high voltage, such as a battery voltage, to the coils via the half bridges mentioned above, for example.

When an electric motor is used in a drive of a vehicle, the certain detection of an instantaneous state of the electric motor is of decisive importance for safety, in order to detect an undesired or malfunctioning drive. To do this, the actual state of the electric motor may be compared, for instance, to a state of the electric motor that is to be expected, which may be ascertained, for instance, with the aid of a characteristic curve, an error being detected if there is a non-agreement.

Moreover, the certain determination of the actual torque of the electric motor is a necessary component of the requirements of the functional certainty of the electric drive. For this, one may draw a conclusion as to the torque, for instance, with the aid of the electric power which may be determined from a measurement of the battery current and the battery voltage as well as the rotational speed. However, for lower rotational speeds, this method becomes increasingly inaccurate, since for setting a certain torque, and thus a certain vehicle acceleration, less and less power is required. This leads to uncertainty, since, particularly at low torques, power is able to be detected, for instance, based on a current measurement, in which one is no longer able to decide unequivocally whether a torque is present or not. This uncertainty is disadvantageous, especially at low rotational speeds, because, for example, an undesired motion starting from a rotational speed of 0, that is, from a standstill, is regarded as being particularly critical, since it cannot be made sure that there is even a driver located in the vehicle. In addition, for vehicles having for example one electrical axle, it is not possible, using a transmission or a clutch, to interrupt the power transmission between the electric motor and the wheels. Thus, in a case of malfunction, the standard ECE R100 requires for electrically driven vehicles, that is, for electric vehicles and for hybrid vehicles, a limitation of malfunction-induced, undesired motion to 10 cm.

### SUMMARY

In accordance with the present invention, a drive state of an electric motor is able to be monitored efficiently, especially in the low rotational speed range especially if, besides the states of the half bridges which are put into a bridge inverter, control signals are also evaluated which are used to control the half bridges. The control signals may be logic signal, for example, which are used for controlling the switches of the half bridges. However, the control signals may be voltage signals, with which the half bridges are controlled. If, for example, the state of a respective half bridge does not agree with the state of the half bridge that is connected to the detected control signal, an error is detected.

According to one example aspect, the present invention relates to a method for monitoring a drive state, particularly a non-driven drive state of an electric motor, which is supplied with energy using a bridge inverter having at least one half bridge. An example method includes detecting a state of the at least one half bridge, the detecting of a property of a control signal for controlling the at least one half bridge, and the monitoring of the drive state based on the detected state of the at least one half bridge and the detected property of the control signal. Consequently, the drive state may advantageously have its plausibility checked in a simple manner.

According to one specific embodiment, the property of the control signal is the absence of a control signal or the presence of the control signal or a side of the control signal, particularly a rising or a falling side, or a pulse or a pulse duration or a pulse time. In this way, a flexibility of detection is achieved in an advantageous manner.

According to one specific embodiment, to monitor the drive state, it is checked whether the detected state of the at least one half bridge and the detected property of the control signal correspond to each other. Alternatively, for monitoring the drive state, it may be checked whether the detected state of the at least one half bridge and the property of the control signal, especially the absence or the presence of a control signal, are able to be assigned to the same drive state. Furthermore, one may detect a faulty drive state if the detected state of the at least one half bridge and the property of the control signal are not able to be assigned to the same drive state. In this way, a simple monitoring of the drive state may be implemented in an advantageous manner.

According to one specific embodiment, in the step of detecting the state, it is detected whether the at least one half bridge is open or closed. In this way, especially in the case of the development of the at least one half bridge in the form of a transistor switch, its state may be detected simply and quickly.

According to one specific embodiment, the drive state includes a freewheeling or a short-circuit torque or a rotational speed or a drive torque or a braking torque or an undefined drive state. Thus, a plurality of different drive states is able to be monitored in an advantageous manner.

According to one specific embodiment, the drive state is monitored with the aid of a table, a look-up table, for example, in which a property of the control signal and/or a state of the at least one half bridge is assigned to a drive state, respectively. In this way, the monitoring is able to be carried out in an especially simple manner.

According to one specific embodiment, in response to an open state of the at least one half bridge and an absent control signal, freewheeling of the electric motor is detected. Alternatively, in response to a closed state of the at least one half bridge and an absent control signal, a short-circuit torque of the electric motor is detected. In this way, the monitoring is able to be implemented in a particularly simple manner based on binary decisions.

According to one specific embodiment, the inverter includes an additional half bridge assigned to the at least one half bridge, the at least one half bridge being an upper or a lower half bridges, and the additional half bridge being a lower or an upper half bridge. The method includes detecting a state of the upper half bridge and a state of the lower half bridge, detecting a property of a control signal for controlling the upper half bridge, and a property of a control signal for controlling the lower half bridge, and the monitoring of the drive state based on the detected state of the upper and the lower half bridge as well as the detected properties of the control signals for controlling the upper and the lower half bridge. In this way, the monitoring may be carried out particularly certainly.

According to one specific embodiment, a certain drive state of the absent control signal of the electric motor and/or of a certain combination of the states is assigned to the upper and the lower half bridge. In this way, an advantageously rapid monitoring of the electric motor may be carried out.

According to one specific embodiment, a drive state of the electric motor is detected as being faulty if a control signal for controlling the upper half bridge is detected and a control signal for controlling the lower half bridge is not detected because of its absence, or if a control signal for controlling the upper half bridge is not detected based on its absence and a control signal for controlling the lower half bridge is detected. In this way, a faulty drive state is detected in a particularly simple manner.

According to one additional aspect, the present invention relates to a control unit which is equipped with program technology to run a computer program for carrying out the method according to the present invention.

### BRIEF DESCRIPTION OF THE DRAWINGS

Additional exemplary embodiments of the present invention are explained with reference to the figures.

FIG. 1 shows the drive of an electric motor.

FIG. 2 shows a drive cycle.

FIG. 3 shows a drive cycle.

FIG. 4 shows a drive cycle.

FIG. 5 shows a drive cycle.

FIG. 6 shows a control unit.

### DETAILED DESCRIPTION OF EXAMPLE EMBODIMENTS

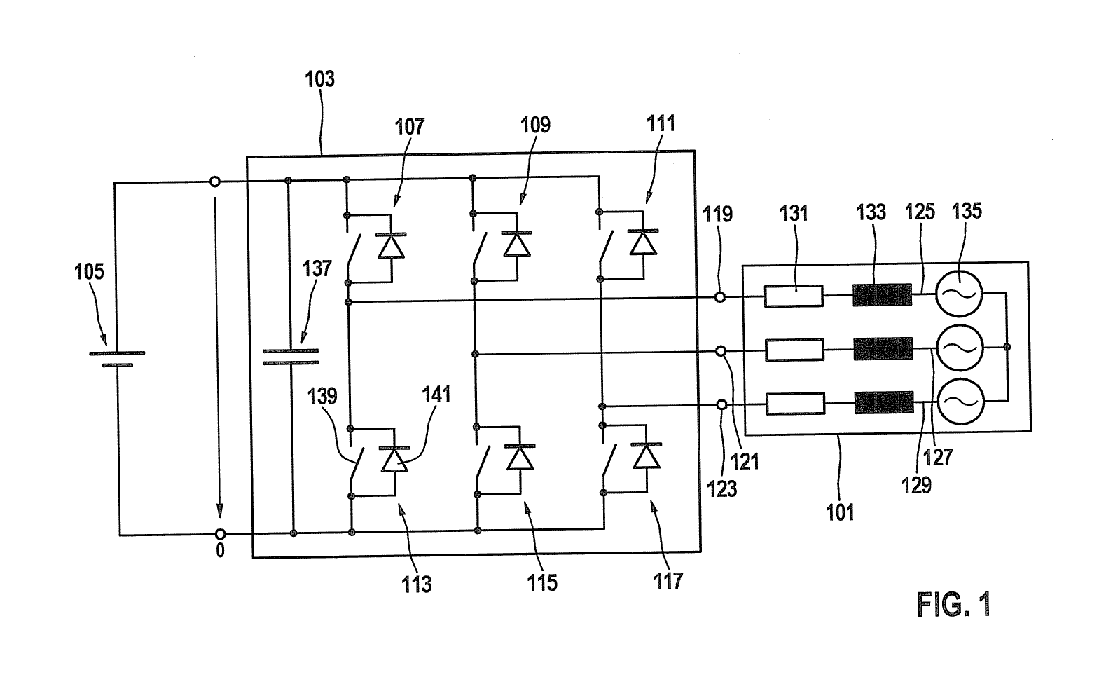

FIG. 1 shows the drive of an electric motor 101, for instance, of a synchronous motor, which may be three-phase or polyphase, while using a bridge inverter 103 which is fed by an energy store 105, a vehicle battery, for example. Bridge inverter 103 includes upper half bridges 107, 109 and 111, which are acted upon by the positive potential of energy store 105. Furthermore, lower half bridges 113, 115 and 117 are provided, which are acted upon by the negative potential or by ground. In this context, each of upper half bridges 107, 109 and 111 has a lower half bridge 113, 115 or 117 assigned to it, so that bridge inverter 103 in each case includes, for example, three arrangements, for example, connected in parallel of upper half bridges and lower half bridges respectively connected one after the other. Between the connecting points between the respective upper half bridge 107, 109 and 111 and the respective lower half bridge 113, 115 and 117, terminals 119, 121 and 123 are situated and brought out, which are respectively connected to cords 125, 127 and 129, which each represent a phase path. Each cord 125, 127, 129 is characterized by a resistor 131, an inductor 133 and a voltage source 135. The three cords of electric motor 101 are brought together at the output end.

Bridge inverter 103 also includes an intermediate circuit capacitor 137, which is preconnected in parallel to the half bridge. Each half bridge includes respectively one transistor switch 139, for example, a power transistors as well as a freewheeling diode 141. For driving the half bridges, transistor switches 139 are opened or closed, whereby voltage, pulses to be transmitted to electric motor 101 are generated whose width determines the power supplied to electric motor 101.

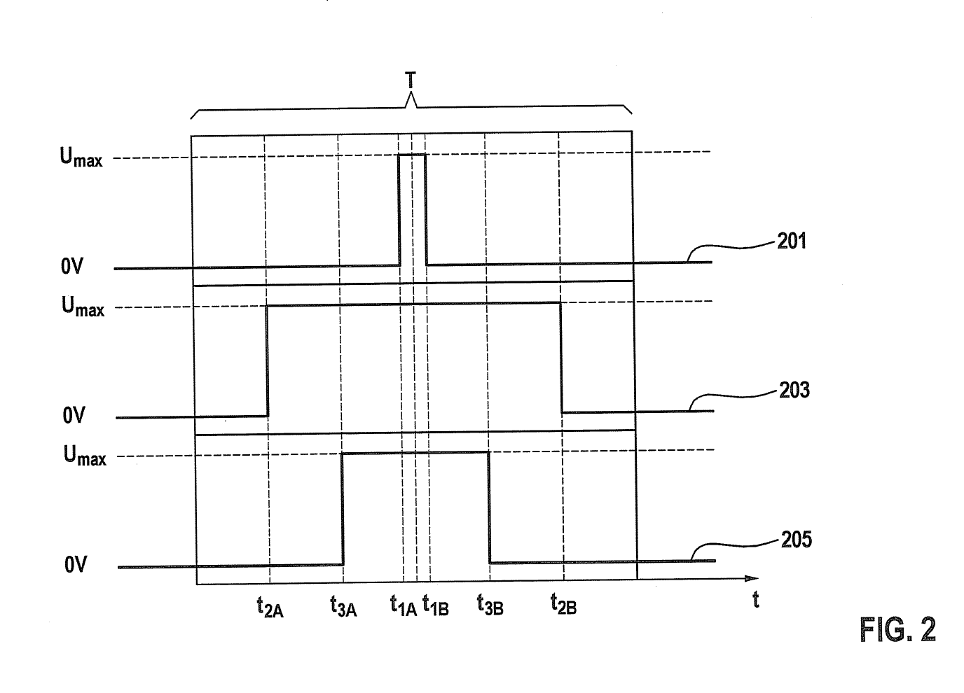

FIG. 2 shows a drive cycle having a time duration T. In this context, the curves of the voltages are shown among one another, voltage 201 at terminal 119 shown in FIG. 1, voltage 203 at terminal 121 shown in FIG. 1 and voltage 205 at terminal 123 shown in FIG. 1 being shown. In this instance, beginning with 0 V pulses, for instance, pulses of different duration are generated, whereby a certain torque is able to be produced.

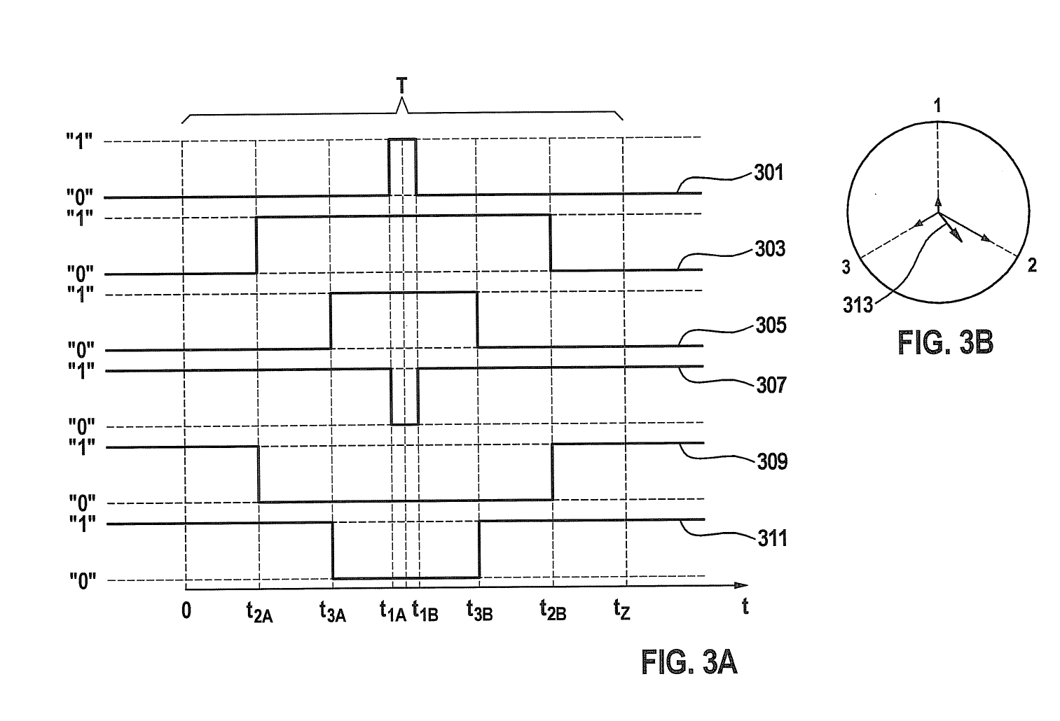

FIG. 3 shows a drive cycle using the drive curves shown in FIG. 2A and the voltage phasor curves shown in FIG. 3B.

The drive cycle shown in FIG. 3A has a total duration T, curve 301 showing the drive of upper half bridge 107 shown in FIG. 1, curve 303 showing the drive of upper half bridge 109 and curve 305 showing the drive of upper half bridge 111. In this instance, the respective transistor switches of the respective half bridge are driven. In contrast, curves 307, 309 and 311 each show the drive of lower half bridges 113, 115 and 117. “1” and “0” respectively characterize “high” and “low” states.

FIG. 3B shows the resulting voltage phasors, that are different from 0, of phases 1, 2 and 3, as well as resulting voltage phasors 313 which points to an ascertained torque that is different from 0.

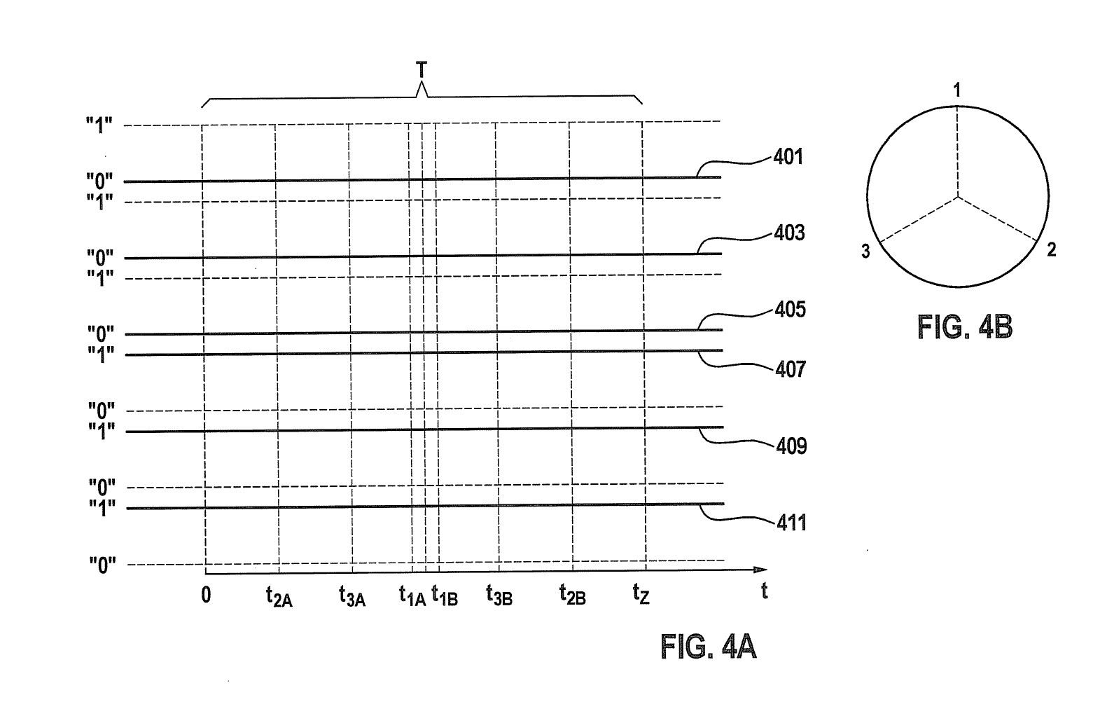

FIG. 4A shows drive curves for the case in which a short circuit torque is present. In this context, curves 401, 403 and 405 each show the drive signals of upper half bridges 107, 109 and 111. In contrast, curves 407, 409 and 411 show the drive signals of lower half bridges 113, 115 and 117.

FIG. 4B shows the ascertained voltage phasor, which is equal to 0, from which one may conclude that there is a short circuit torque.

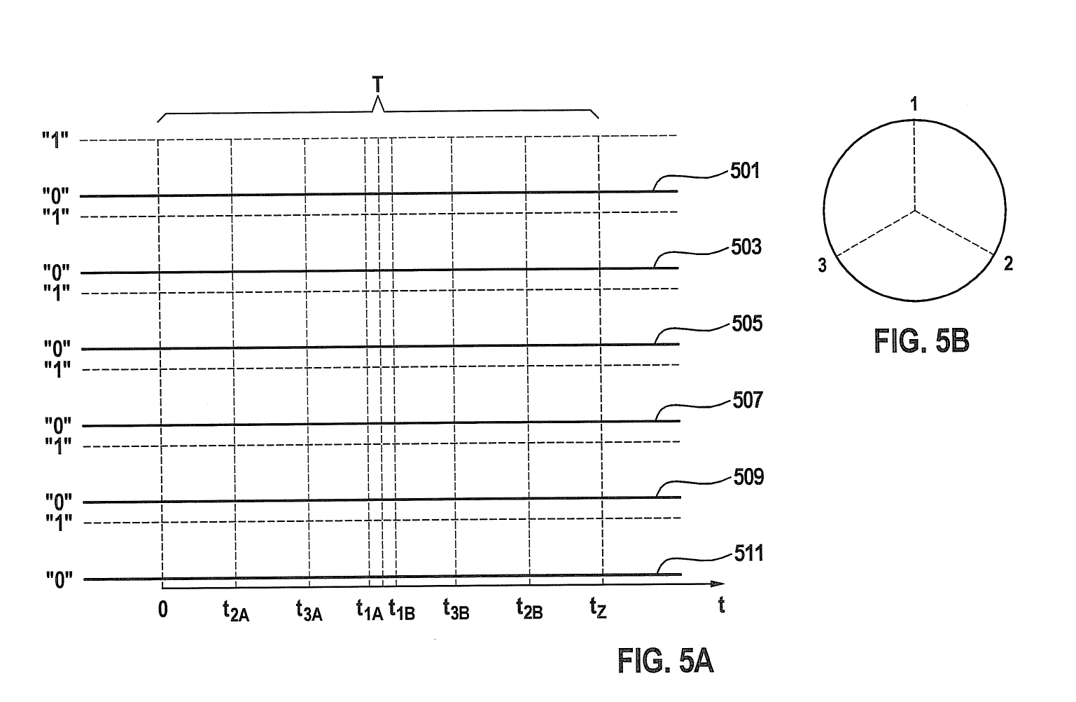

FIG. 5A shows the drive curves for the case of a freewheeling torque. In this context, FIG. 5A shows curves 501, 503 and 505 each show the drive signals for upper half bridges 107, 109 and 111. In contrast, curves 507, 509 and 511 show the drive signals for driving lower half bridges 113, 115 and 117.

As shown in FIG. 5B, the ascertained voltage phasor is equal to 0, which, in this case, points to a freewheeling torque.

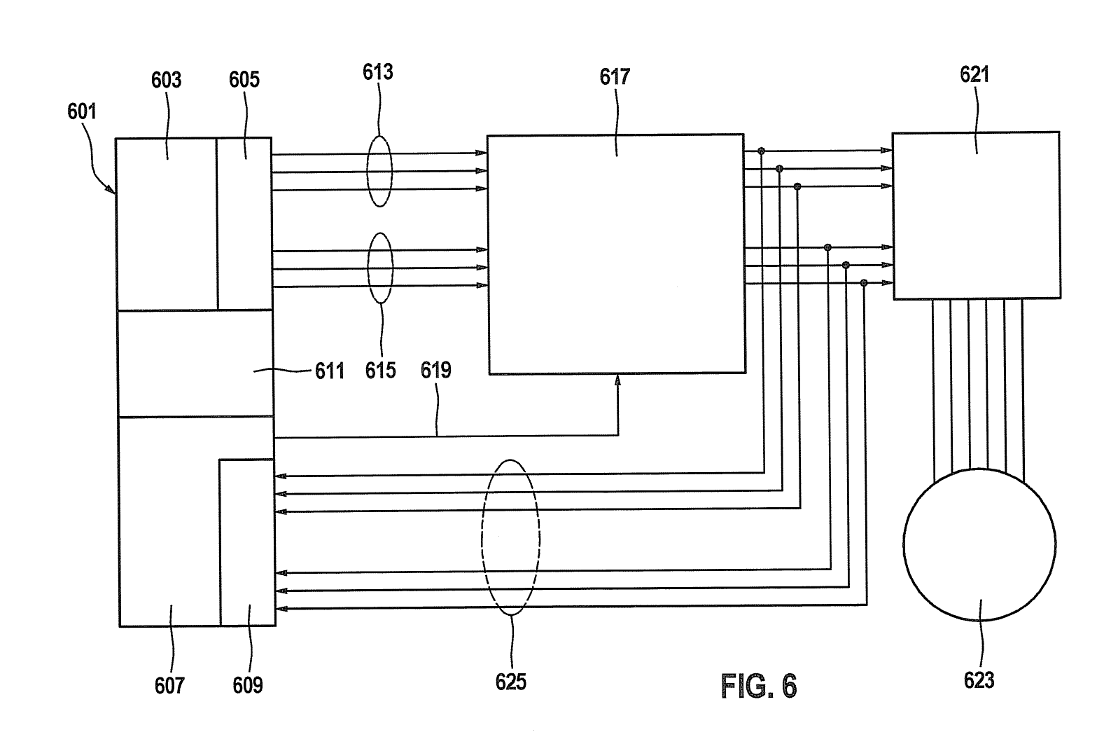

FIG. 6 shows a control unit 601 having a regulating device 603 which is implemented using regulating software, for example, a timer unit 605, a monitoring unit 607, which is implemented using monitoring software, for instance, and an additional timer unit 609. In addition, a functional calculator 611 is provided.

Using timer unit 605, digital drive signals 613 are emitted for the upper half bridges as well as digital drive signal 615 for the lower half bridges, and are supplied to a logic module 617. Logic module 617 includes a discrete logic, for example, for instance a fault logic and/or a hardware implementation or a hardware setting of a lower active short circuit of the electric motor or of a freewheeling.

Unit 607 furthermore emits a digital signal 619 for the fault reaction, for example, in case of a lower active short circuit, which signal is supplied to the discrete logic module. Discrete logic module 617 is provided to drive output stages 621 of the half bridges, for instance, power switches as well as IGBT's, output stages 621 conducting high voltage drive signals to electric motor 623.

The drive signals supplied to output stages 621, that is, the half bridges, are fed to timer unit 609 for further detection. Consequently, the drive signals actually driving the half bridges are provided for evaluation.

It is possible, according to the present invention, to monitor, with great accuracy, the keeping up of a non-driven state of the electric drive having an electric motor. Thus, for example, states not having a drive torque at standstill or having a specified drag torque, a freewheeling, for example, lower or upper short-circuit, may be delimited from those operating states which potentially carry a residual torque. In the case of a fault in the shape of an undesired torque, a deviation in the desired operating state from the determined operating state may be determined and, if necessary, a substitute reaction or a fault reaction may be initiated, which may include switching off the torque-determined end stages, such as the switching transistors of the affected half bridges.

To do this, as shown in FIG. 6, pulsed drive signals 625 of the synchronous motor of the electric drive are fed to the control unit entrusted with the control, which may include a functional calculator or a microcontroller. The interpretation of the read-back drive signals is drawn upon for identifying and for monitoring the current operating state. Consequently, it is possible to determine the operating state and, in this instance, particularly to distinguish between states having or not having propelling torque.

As shown in FIG. 6, the drive signals for the banks of coils of electric motor 623, after processing perhaps, are able to be fed back through logic module 617 to the inputs of control unit 601. This reading back could also take place using an independent microcontroller, within the meaning of an additional diversifying redundancy. Control unit 601 is preferably in a position to record the curve of the signals, such as the times of the rising or falling sides, using a specified accuracy in time, for example. In this context, the reading in is of a nature such that each appearing side, such as a rising or a falling side, is detected and its time stamp is recorded.

The evaluation of the read-back drive signals is made up, with the aid of the instantaneous state of the half bridges, which may be open or closed, and the switching activities of output stages 621, detected with the aid of the read-back signals, for instance by the detection or by a non-detection of the sides, the pulse times and the pulse lengths, of drawing a conclusion of the operating state of the current regulation, particularly on the instantaneous voltage phasor in the reference system of the rotor of electric motor 623. The procedure is as follows:

If the upper and the lower half bridges are open and neither pulses for the lower half bridges nor pulses for the upper half bridges are detected, a freewheeling is detected. The torque assigned to this state is 0 at low rotational speeds, but at high rotational speeds a braking torque is possible by rectifier effects in the electric motor.

If the upper half bridges are open and the lower half bridges are closed, and no pulses for the lower half bridges nor pulses for the upper half bridges are detected, a lower active short-circuit (uAKS) is detected. The torque assigned to this state is a short circuit torque or a drag torque.

If the upper half bridges are closed and the lower half-bridges are open and if no pulses for the upper and the lower half bridges are detected, an upper active short circuit (oAKS) is detected. A short circuit torque or a drag torque is assigned to this operating state.

If pulses are detected in the case of the lower and the upper half bridges, a present moment is detected, to which any torque may be assigned. In this connection, the states of the upper and the lower half bridges are irrelevant.

If, for example, pulses are detected in the lower half bridges and no pulses are detected in the upper half bridges, or pulses are detected not in the case of all half bridges, an undefined state is detected, which may be classified as potentially torque-producing. In this connection, the states of the upper and the lower half bridges are irrelevant.

If, for example, pulses are detected in all the upper half bridges and pulses are detected in the lower half bridges, or not in the case of all half bridges, an undefined state is again detected, to which may be assigned a potentially arbitrary torque. In this context, the states of the upper and the lower half bridges are irrelevant.

If pulses are detected not in all the upper half bridges, an undefined state is detected, to which may be assigned an undefined, potentially arbitrary torque. In this context, the states of the upper and the lower half bridges are irrelevant.

If, in the case of torques being present, the detected pulses run synchronously on all three phases of the electric motor, one may assume that there are no voltages present at the banks of coils themselves. This corresponds to a steady change between the lower active short circuit and the upper active short circuit, so that torque present essentially corresponds to the short-circuit torque.

1-11. (canceled)

12. A method for monitoring a drive state of an electric motor which is fed with energy using a bridge inverter having at least one half bridge, the method comprising:
detecting a state of the at least one half bridge;
detecting a property of a control signal for driving the at least one half bridge; and
monitoring the drive state based on the detected state of the at least one half bridge and the detected property of the control signal.

13. The method as recited in claim 12, wherein the monitored drive state is a non-driven drive state.

14. The method as recited in claim 12, wherein the property of the control signal includes one of: i) an absence of the control signal, ii) a presence of the control signal, iii) a rising or falling side of the control signal, iv) a pulse of the control signal, v) a pulse duration of the control signal, or vi) a pulse time of the control signal.

15. The method as recited in claim 12, wherein one of: i) the monitoring of the drive state includes checking whether the detected state of the at least one half bridge and the detected property of the control signal correspond to each other, ii) the monitoring of the drive state includes checking whether the detected state of the at least one half bridge and the property of the control signal are able to be assigned to a same drive state, or iii) a drive state is detected as being faulty if the detected state of the at least one half bridge and the property of the control signal are not able to be assigned to the same drive state.

16. The method as recited in claim 12, wherein the detecting of the state includes detecting whether the at least one half bridge is open or closed.

17. The method as recited in claim 12, wherein the drive state includes one of a freewheeling drive state, a short-circuit torque drive state, a rotational speed drive state, a drive torque drive state, a braking torque drive state, or an undefined drive state.

18. The method as recited in claim 12, wherein the drive state is monitored with the aid of a table, in which at least one of a property of the control signal, and a state of the at least one half bridge, is assigned to one drive state, respectively.

19. The method as recited in claim 12, wherein, one of: i) in the case of an open state of the at least one half bridge and an absent control signal, a freewheeling of the electric motor is detected, or ii) in the case of a closed state of the at least one half bridge and an absent pulse of the control signal, a short-circuit torque of the electric motor is detected.

20. The method as recited in claim 12, wherein the inverter has an additional half bridge which is assigned to the at least one half bridge, the at least one half bridge being an upper half bridge or a lower half bridge, and the additional half bridge being a lower or an upper half bridge, and the method further comprising:
detecting of a property of a control signal for driving the upper half bridge and of a control signal for driving the lower half bridges; and
monitoring the drive state based on the detected states of the upper half bridge and the lower half bridge, and detected properties of control signals for driving the upper half bridge and the lower half bridge.

21. The method as recited in claim 20, wherein at least one of a certain drive state of the electric motor is assigned to absent control signals, and a certain combination of states is assigned to the upper half bridge and the lower half bridge.

22. The method as recited in claim 20, wherein a drive state is detected as being faulty if one of a control signal for controlling the upper half bridge is detected and a control signal for controlling the lower half bridge is not detected, or in case a control signal for controlling the upper half bridge is not detected and a control signal for controlling the lower half bridge is detected.

23. A control unit to monitor a drive state of an electric motor which is fed with energy using a bridge inverter having at least one half bridge, the control unit configured to detect a state of the at least one half bridge, to detect a property of a control signal for driving the at least one half bridge, and to monitor the drive state based on the detected state of the at least one half bridge and the detected property of the control signal.
